(19) United States
(12) Patent Application Publication
(10) Pub. No.: US 2018/0091328 A1
(43) Pub. Date: Mar. 29, 2018

(54) PROMPTING METHOD, PROMPTING DEVICE AND PROMPTING SYSTEM

(71) Applicant: Beijing Xiaomi Mobile Software Co., Ltd., Beijing (CN)

(72) Inventors: Tao CHEN, Beijing (CN); Huayijun LIU, Beijing (CN); Mingyong TANG, Beijing (CN)

(73) Assignee: Beijing Xiaomi Mobile Software Co., Ltd., Beijing (CN)

(21) Appl. No.: 15/708,934

(22) Filed: Sep. 19, 2017

(30) Foreign Application Priority Data
Sep. 29, 2016 (CN) 201610868518.6

(51) Int. Cl. H04L 12/28

(52) U.S. Cl. CPC H04L 12/2823; H04L 12/283

(57) ABSTRACT

The present disclosure relates to prompting methods, devices and systems. In some aspects, a prompting method is provided, which includes generating and/or receiving notification information using notification sending equipment, and sending the notification information to a gateway connected to the notification sending equipment. The method also includes receiving feedback from the gateway, and executing a prompting action based on the feedback.

### CROSS-REFERENCE TO RELATED APPLICATIONS

This application is filed based upon and claims priority to Chinese Patent Application No. CN201610868518.6, filed on Sep. 29, 2016, the entire contents of which are incorporated herein by reference.

### TECHNICAL FIELD

The present disclosure generally relates to prompting, and more particularly systems, devices and methods for prompting.

### BACKGROUND

Recent years have seen a dramatic increase in the development of sciences and technologies related to personal and commercial devices and products, including Wireless Fidelity (WIFI) technologies in the Internet of things and products providing immersive or sensory experiences, such as a Virtual Reality (VR) products and headsets. However, such immersive or sensory devices tend to isolate or reduce user awareness of the environment. As a result, there is an increased likelihood that users may miss important external information, activities or events, and in some cases be subjected to dangerous conditions.

### SUMMARY

According to a first aspect of the present disclosure, a prompting method is provided, which may be applied to notification sending equipment and include: when notification information is received, sending the notification information to a gateway connected with the notification sending equipment; and receiving a feedback from the gateway, and executing a corresponding prompting action.

According to a second aspect of the embodiments of the present disclosure, a prompting method is provided, which may be applied to a home gateway and include: when notification information sent by notification sending equipment connected to the gateway is received, determining whether notification receiving equipment connected to the home gateway is in a preset state; if it is determined that the notification receiving equipment is in the preset state, forwarding the notification information to the notification receiving equipment; and if it is determined that the notification receiving equipment is not in the preset state, returning a notification message to the notification sending equipment.

According to a third aspect of the embodiments of the present disclosure, a prompting method is provided, which may be applied to notification receiving equipment and include: sending a current state to a gateway; receiving a notification message from a notification sending equipment sent by the gateway; and performing a message prompting operation according to the notification message.

According to a fourth aspect of the embodiments of the present disclosure, a prompting device is provided, which may be applied to notification sending equipment and include: an information sending module, configured to send notification information to a gateway connected with a notification sending equipment when the notification information is received; and a first prompting module, configured to receive a feedback from the gateway and execute a corresponding prompting action.

According to a fifth aspect of the embodiments of the present disclosure, a prompting device is provided, which may be applied to a home gateway and include: a determination module, configured to determine whether a notification receiving equipment connected to the gateway is in a preset state when notification information sent by a notification sending equipment connected to the gateway is received; a forwarding module, configured to forward the notification information to the notification receiving equipment when the determination module determines that the notification receiving equipment is in the preset state; and a returning module, configured to return a notification message to the notification sending equipment when the determination module determines that the notification receiving equipment is not in the preset state.

According to a sixth aspect of the embodiments of the present disclosure, a prompting device is provided, which may be applied to notification receiving equipment and include: a state sending module, configured to send a current state to a gateway; a receiving module, configured to receive a notification message from a notification sending equipment sent by the gateway; and a second prompting module, configured to perform a message prompting operation according to the notification message received by the receiving module.

According to a seventh aspect of the embodiments of the present disclosure, a prompting device is provided, which may be applied to notification sending equipment and include: a processor; and a memory configured to store instructions executable by the processor. The processor may be configured to execute the instructions to: when notification information is received, send the notification information to a gateway connected with a notification sending equipment; and receive a feedback of the gateway and execute a corresponding prompting action.

According to an eighth aspect of the present disclosure, a prompting device is provided, which may be applied to a gateway and include: a processor; and a memory configured to store instructions executable by the processor. The processor may be configured to execute the instructions to: when notification information sent by a notification sending equipment connected to a gateway is received, determine whether notification receiving equipment connected to the home gateway is in a preset state; if it is determined that the notification receiving equipment is in the preset state, forward the notification information to the notification receiving equipment; and if it is determined that the notification receiving equipment is not in the preset state, return a notification message to the notification sending equipment.

According to a ninth aspect of the embodiments of the present disclosure, a prompting device is provided, which may be applied to notification receiving equipment and include: a processor; and a memory configured to store instructions executable by the processor. The processor may be configured to execute the instructions to: send a current state to a gateway; receive a notification message from a notification sending equipment sent by the gateway; and perform a message prompting operation according to the notification message.

According to a tenth aspect of the embodiments of the present disclosure, a prompting system is provided, which may include: notification sending equipment, a gateway and a notification receiving equipment. The notification sending equipment may include the prompting device mentioned in the fourth aspect. The gateway may include the prompting device mentioned in the fifth aspect. The notification receiving equipment may include the prompting device mentioned in the sixth aspect.

According to an eleventh aspect of the embodiments of the present disclosure, a prompting system is provided, which may include: the notification sending equipment mentioned in the seventh aspect; the home gateway mentioned in the eighth aspect; and the notification receiving equipment mentioned in the ninth aspect.

It should be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart setting forth steps of a process in accordance with aspects of the present disclosure.

FIG. 2 is another flowchart setting forth steps of another process in accordance with aspects of the present disclosure.

FIG. 3 is yet another flowchart setting forth steps of yet another process in accordance with aspects of the present disclosure.

FIG. 4 is yet another flowchart setting forth steps of yet another process in accordance with aspects of the present disclosure.

FIG. 5 is yet another flowchart setting forth steps of yet another process in accordance with aspects of the present disclosure.

FIG. 6 is a block diagram illustrating a prompting device, in accordance with aspects of the present disclosure.

FIG. 7 is a block diagram illustrating an example of a first prompting module in a prompting device according to FIG. 6.

FIG. 8 is a block diagram illustrating another example of a first prompting module in a prompting device according to FIG. 6.

FIG. 9 is a block diagram illustrating a prompting device, in accordance with aspects of the present disclosure.

FIG. 10 is a block diagram illustrating a prompting device, in accordance with aspects of the present disclosure.

FIG. 11 is a block diagram illustrating a prompting system, in accordance with aspects of the present disclosure.

FIG. 12 is a block diagram illustrating a prompting device, in accordance with aspects of the present disclosure.

FIG. 13 is a block diagram illustrating a prompting device, in accordance with aspects of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise specified. The implementations set forth in the following description of exemplary embodiments do not represent all implementations consistent with the present disclosure. Rather, they are merely examples of apparatuses and methods consistent with aspects related to the present disclosure as recited in the appended claims.

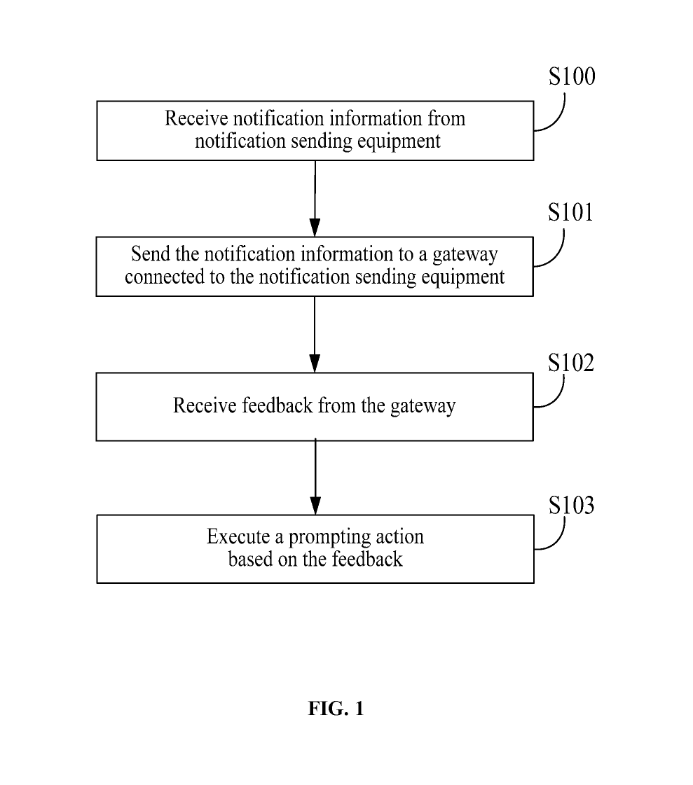

Referring now to FIG. 1, a flowchart setting forth steps of a process, in accordance with aspects of the present disclosure, is illustrated. The process may be carried out by a variety of suitable devices, systems and apparatuses, including those described in the present disclosure. In some embodiments, the process may be executed by various notification sending equipment, such as connectable or intelligent devices, systems or apparatuses. Non-limiting examples may include a washing machine, a doorbell, a kitchen appliance, an alarm, and so on. The process may be embodied as a program, firmware, software or instructions stored in a memory, such as a non-transitory computer readable medium or other data storage medium, and executed by one or more processors associated with, or connected to, the notification sending equipment.

As shown in FIG. 1, the process may optionally begin at Step S100 with generating notification information, which may indicate a state, condition, or operation of the notification sending equipment as well as provide other information. In some aspects, the sending notification equipment may include one or more devices, systems, or apparatuses. To this end, notification information may be generated and transmitted between various devices, systems, or apparatuses, as well as between various components therein. Non-limiting examples of notification information may include a ringing notification produced by an intelligent doorbell, a washing completion notification produced by a washing machine, a cooking completion notification produced by a kitchen appliance, an alarm notification produced by a device, and so on.

At Step S101, when notification information is generated and/or received by the sending notification equipment, such notification information may then be sent to a gateway that is connected to the notification sending equipment. The notification information may be sent via one or more wired or wireless connections using various communication protocols. In one example, the gateway may be a home gateway that may connect to, form, or be part of a home or residential network, a business network, a public network, and so forth. In some aspects, the notification sending equipment need not directly provide a prompt upon generating or receiving the notification information.

At Step S102, feedback, from the gateway may then be received by the notification sending equipment. In some aspects, upon receipt of the notification information from the notification sending equipment, the gateway may generate and send feedback thereto according to a state of notification receiving equipment, as well as according to other information. A prompting action based on the feedback may then be executed by the notification sending equipment, as indicated by Step S103. For example, the notification sending equipment may independently provide a prompt in accordance with the notification information. Alternatively, the notification sending equipment need not provide the prompt.

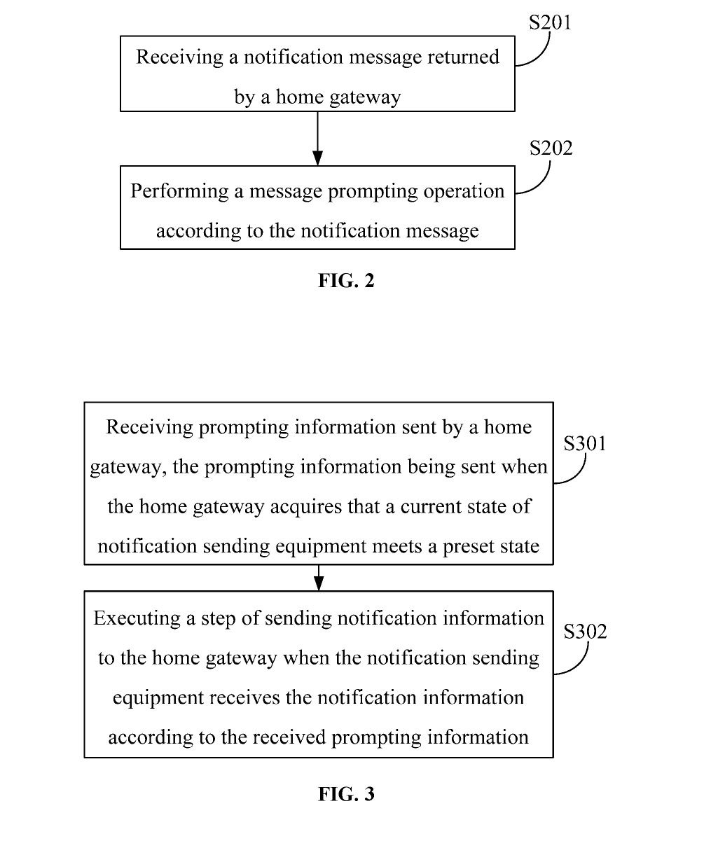

FIG. 2 is a flowchart showing one implementation of Steps S102 and S103 described with respect to FIG. 1. Specifically, at step 202, feedback in the form of a notification message returned by the gateway is received. To this end, the gateway is configured to determine whether or not the notification receiving equipment connected to the gateway is in an in-service state or in an immersive experience state when receiving the notification information. If the notification receiving equipment is in the in-service state or the immersive experience state, the gateway may then forward the notification information to the notification receiving equipment. The notification receiving equipment may then provide a prompt corresponding to the notification information or the prompting information. If the notification receiving equipment is not in the in-service state or the immersive experience state, the gateway may then return the notification message to the notification sending equipment, where the notification message may be different from the notification information. For instance, the notification message may only be a message that causes the notification sending equipment to make the prompt. Of course, the notification message may also be the same, or include the same information, as the notification information. Then the notification sending equipment can directly provide the prompt upon receiving the notification information.

In Step S203, a message prompting operation is performed according to the notification message. Specifically, when the notification sending equipment receives the notification message sent by the gateway, it is indicated that the notification receiving equipment connected to the gateway may not make the prompt about the notification information. The notification sending equipment may then perform the prompting operation based on the notification information. For instance, the notification sending equipment may output the notification information, thereby making it convenient for the user to receive such notification information.

FIG. 3 is a flowchart showing another implementation of Steps S102 and S103 described with respect to FIG. 1. Specifically, at step S302, prompting information sent by the gateway is received, where the prompting information is sent upon the gateway determining whether a current state of the notification sending equipment meets a preset state. For instance, the preset state may be an immersive experience state. In some aspects, the gateway may send the prompting information to the notification sending equipment upon determining that the current state of the notification receiving equipment meets the immersive experience state, thereby prompting the notification sending equipment that the user is in the immersive experience. The notification information may then be sent to the notification receiving equipment for prompting to prevent the user from missing any important prompt.

In Step S303, the notification information is sent to the gateway upon the notification sending equipment receiving the notification information according to the received prompting information. Specifically, upon receiving the prompting message, the notification sending equipment may then forward the notification information to the notification receiving equipment through the gateway. In some aspects, the notification information may be forwarded through the gateway only when the notification receiving equipment is in the immersive experience. In this manner, resource waste caused by continuous forwarding to or by the gateway when the notification information is not required to be forwarded may be avoided. As such, users may be prevented from missing important prompting information while being in an immersive experience process, and user experiences may be improved.

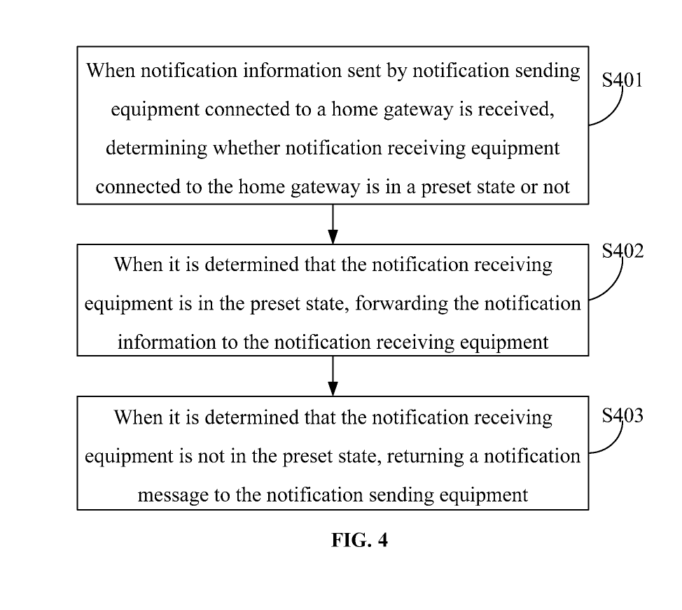

FIG. 4 is a flowchart setting forth steps of another process in accordance with aspects of the present disclosure. The process may be carried out by a variety of suitable devices, systems and apparatuses, including those described in the present disclosure. In some embodiments, the process may be executed by a gateway, as described. The process may be embodied as a program, firmware, software or instructions stored in a memory, such as a non-transitory computer readable medium or other data storage medium, and executed by one or more processors associated with, or connected to, the gateway.

The process may begin with Step S401 with determining whether notification receiving equipment connected to a gateway is in a preset state. In particular, the gateway may be configured to make such determination upon receiving notification information sent by notification sending equipment connected to the gateway. Herein, the notification receiving equipment may be connected to the gateway by way of wired or wireless connections. Non-limiting examples of notification receiving equipment may include VR products, headsets, televisions, computers, mobile phones, tablets, and so on.

At Step S402, the notification information is forwarded to the notification receiving equipment. This step may be performed upon the determination that the notification receiving equipment is in the preset state, such an in-service state or an immersive state. In some aspects, when the notification receiving equipment is in the in-service state, the notification information received by the notification sending equipment may be forwarded to the notification receiving equipment and the notification receiving equipment makes a prompt about the notification information. In this manner, as long as the notification receiving equipment is in service, the notification receiving equipment makes the prompt about the notification information for a user to conveniently receive the prompt. In some aspects, when the notification receiving equipment is in the immersive experience state, the notification information received by the notification sending equipment may also be forwarded to the notification receiving equipment, so that the notification receiving equipment makes the prompt about the notification information. In this manner, the user in an immersive experience may be prevented from missing any external important prompt, and user experiences are improved.

In some implementations, the notification receiving equipment may include multiple devices, systems and apparatuses. As such, when more than one of these are in the preset state, as described, notification information may be selectively forwarded to such devices, systems or apparatuses at step S402 according to priorities predefined by the user. For instance, notification information may be forwarded to the notification receiving equipment with a highest priority.

Then, at step S403, a notification message may be returned to the notification sending equipment upon a determination whether the notification receiving equipment is not in the preset state. In some aspects, if the notification receiving equipment is not in the in-service state or the immersive experience state, the gateway may return the notification message to the notification sending equipment. When the notification sending equipment receives the notification message sent by the gateway, it is indicated that the notification receiving equipment connected to the gateway may not make the prompt about the notification information. Thereupon, the notification sending equipment may perform a prompting operation on the notification information. For instance, the notification sending equipment may output the notification information, thereby making it convenient for the user to acquire the notification information.

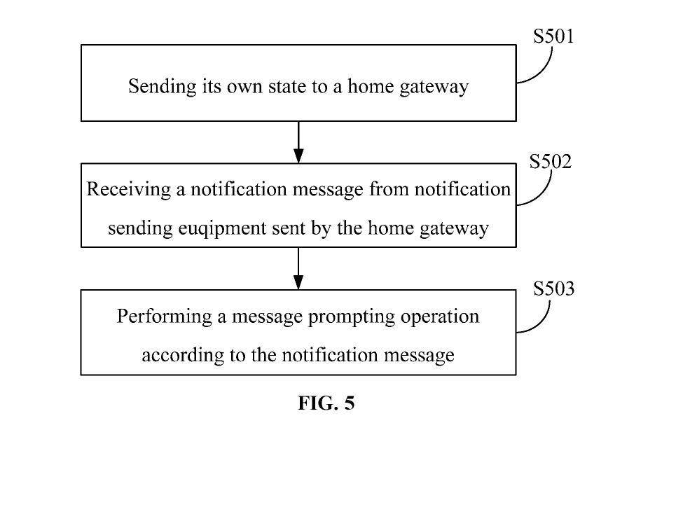

FIG. 5 is a flowchart setting forth steps of another process in accordance with aspects of the present disclosure. The process may be carried out by a variety of suitable devices, systems and apparatuses, including those described in the present disclosure. In some embodiments, the process may be executed by a notification receiving equipment, as described. The process may be embodied as a program, firmware, software or instructions stored in a memory, such as a non-transitory computer readable medium or other data storage medium, and executed by one or more processors associated with, or connected to, the gateway.

The process may begin at step S501 with the notification receiving equipment sending information indicating its current state to a gateway. As an example, the current state may be an in-service state or an out-of-service state. In some aspects, the notification receiving equipment may send the state to the gateway in substantially real time, thereby making it convenient for the gateway to determine whether to forward received notification information sent by notification sending equipment to the notification receiving equipment or not.

If the notification receiving equipment is in the in-service state, the gateway may forward the notification information sent by the notification sending equipment to the notification receiving equipment, so that the notification receiving equipment makes a prompt about the notification information. In this manner, as long as the notification receiving equipment is in service, the notification receiving equipment makes the prompt about the notification information for a user to acquire the prompt. If the notification receiving equipment is in the out-of-service state, the gateway may return a notification message to the notification sending equipment. Upon receiving the notification message sent by the gateway, the notification receiving equipment may not make the prompt about the notification information. As such, the notification sending equipment may then perform the prompting operation on the notification information. For instance, the notification sending equipment may output the notification information, thereby making it convenient for the user to acquire the notification information.

In some aspects, the information sent by the notification receiving equipment at step S501 indicates an immersive experience state. By way of example, an immersive experience state may be when a headset is plugged into a mobile phone, VR equipment is started and a volume of a television is higher than a certain threshold value, and so on. If the notification receiving equipment is in the immersive experience state, the notification information received by the notification sending equipment may also be forwarded to the notification receiving equipment. As such, the notification receiving equipment can provide the prompt about the notification information, and the user may be prevented from missing any external important prompt, allowing for improved user experiences.

Referring again to FIG. 5, the process may then continue at step S502, with receiving a notification message from notification sending equipment sent by the gateway. Then, as indicated by step S503, a message prompting operation according to the notification message may then be performed. In some aspects, the notification sending equipment may send the notification information to the gateway when receiving the notification information. The gateway may then forward the notification information to the notification receiving equipment in the in-service state or in the immersive experience state. As such, the notification receiving equipment can provide a prompt about the notification information. In this manner, when the user is engaged with an immersive experience product, the notification information may be forwarded to the immersive experience product, such as a television and a VR product, through the gateway if being received by the notification sending equipment such as a washing machine and a doorbell, as described. This ensures that the user in the immersive experience may receive important prompting information on the immersive experience product, thereby preventing the user from missing the important prompting information, allowing for improved user experiences.

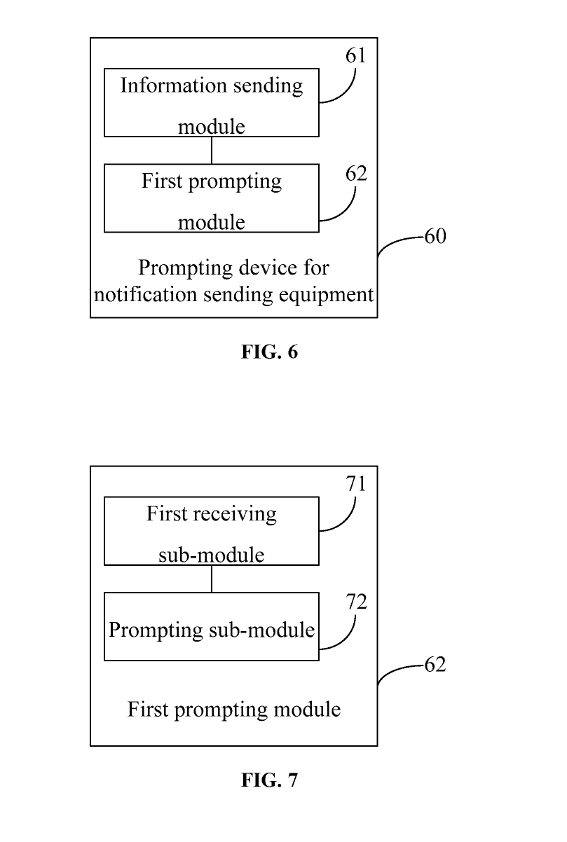

Referring now to FIG. 6, a block diagram is shown illustrating an example prompting device, in accordance with aspects of the present disclosure. The device may be implemented into a part or entire of the notification sending equipment through software, hardware or a combination thereof. As shown in FIG. 6, the prompting device 60 may include an information sending module 61 and a first prompting module 62, and be configured to carry out processes in accordance with the present disclosure.

Specifically, the information sending module 61 is configured to send notification information to a gateway connected with the notification sending equipment. When receiving the notification information, the information sending module 61 may send the notification information to the gateway connected therewith. Herein the notification information may correspond with, for example, an intelligent doorbell receiving a ringing notification, a washing machine receiving a washing completion notification, a kitchen appliance receiving a cooking completion notification, an alarm receiving an alarm notification, and so on. When receiving the notification information, the notification sending equipment does not directly make a prompt, and instead, sends it to the home gateway. Herein the notification sending equipment may access the home gateway in a wired or wireless connection manner.

The first prompting module 62 is configured to receive a feedback of the gateway and execute a corresponding prompting action. Specifically, the gateway may send the feedback to the first prompting module 62 according to a state of notification receiving equipment connected to the gateway when receiving the notification information sent by the notification sending equipment. The first prompting module 62 may then execute the corresponding prompting action according to the feedback of the gateway, for example, independently making the prompt about the notification information or not making the prompt about the notification information.

Referring to FIG. 7, one embodiment of the first prompting module 62 shown in FIG. 6 is illustrated. The first prompting module 62 may include a first receiving sub-module 71 and a prompting sub-module 72. The first receiving sub-module 71 is configured to receive a notification message returned by the gateway. The home determines whether the notification receiving equipment connected to the gateway is in an in-service state or an immersive experience state or not when receiving the notification information. It may forward the notification information to the notification receiving equipment when the notification receiving equipment is in the in-service state or the immersive experience state. Then, the notification receiving equipment makes a prompt about the prompting information. When the notification receiving equipment is not in the in-service state or the immersive experience state, the gateway returns the notification message to the notification sending equipment. Herein the notification message may be different from the notification information, and may only be a message that causes the notification sending equipment to provide the prompt. Of course, it may also be the same as the notification information, and then the notification sending equipment directly provides the prompt after receiving the notification information.

The prompting sub-module 72 of the first prompting module 62 is configured to perform a message prompting operation according to the notification message received by the first receiving sub-module 71. In some aspects, when the notification sending equipment receives the notification message sent by the gateway, it is indicated that the notification receiving equipment connected to the gateway may not make the prompt about the notification information. As such, the notification sending equipment may then perform the prompting operation on the notification information. For example, the notification sending equipment may output the notification information, thereby making it convenient for the user to acquire the notification information.

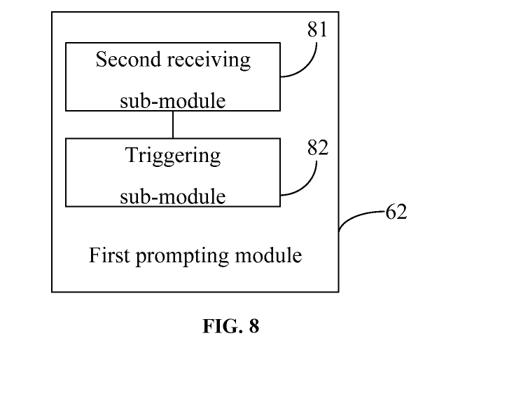

Referring to FIG. 8, another embodiment of the first prompting module 62 shown in FIG. 6 is illustrated. The first prompting module 62 may include a second receiving sub-module 81 and a triggering sub-module 82. The second receiving sub-module 81 is configured to receive prompting information sent by the gateway. Specifically, the prompting information may be sent when the gateway that a current state of the notification sending equipment meets a preset state. As described, the preset state may include an immersive experience state. The gateway may send the prompting information to the notification sending equipment upon a determination that the current state of the notification receiving equipment meets the immersive experience state. This allows the prompting of the notification sending equipment that the user is in the immersive experience and the notification information may be sent to the notification receiving equipment for prompting to prevent the user from missing any important prompt.

The triggering sub-module 82 is configured to trigger the information sending module 61 according to the prompting information received by the second receiving sub-module 81. Upon receiving the prompting message, the notification sending equipment forwards the notification information to the notification receiving equipment through the gateway if the notification information is received. That is, the notification information is forwarded through the gateway only when the notification receiving equipment is in the immersive experience. Therefore, resource waste caused by continuous forwarding of the home gateway when the notification information is not required to be forwarded may be avoided, the user may be prevented from missing any important prompting information in an immersive experience process, and user experiences are improved.

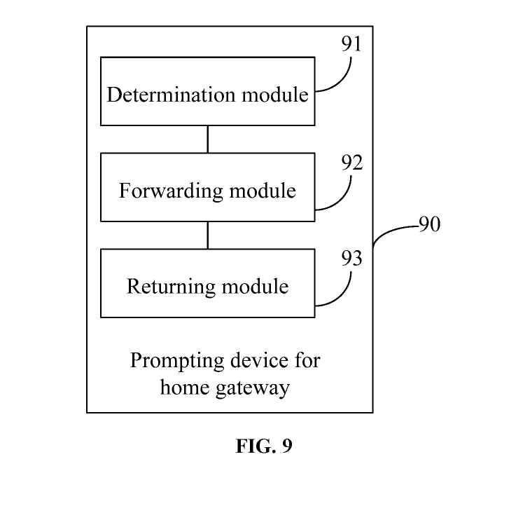

Referring now to FIG. 9, a block diagram is shown illustrating another example prompting device, in accordance with aspects of the present disclosure. The device may be implemented into a part or entire of a gateway through software, hardware or a combination thereof. As shown in FIG. 9, the prompting device 90 may include a determination module 91, a forwarding module 92 and a returning module 93.

The determination module 91 may be configured to determine whether notification receiving equipment connected to the gateway is in a preset state. In some aspects, the determination may be made when notification information sent by notification sending equipment connected to the gateway is received. Herein, the notification receiving equipment may also be connected to the gateway via wired or wireless connection. The notification receiving equipment may be a VR product, a headset, a television, a computer, a mobile phone, and so on, as described.

The forwarding module 92 is configured to forward the notification information to the notification receiving equipment. In some aspects, the forward module 92 may forward the notification information when the determination module 91 determines that the notification receiving equipment is in the preset state, such as an in-service state or an immersive experience state. If the notification receiving equipment is in the in-service state, the notification information received by the notification sending equipment may be forwarded to the notification receiving equipment, so that the notification receiving equipment makes a prompt about the notification information. In this manner, as long as the notification receiving equipment is in service, the notification receiving equipment makes a prompt about the notification information for a user to conveniently acquire the prompt.

If the notification receiving equipment is in the immersive experience state, the notification information received by the notification sending equipment may also be forwarded to the notification receiving equipment, so that the notification receiving equipment makes the prompt about the notification information. In this manner, the user in an immersive experience may be prevented from missing any external important prompt, and user experiences are improved.

As described, notification receiving equipment may include multiple devices, systems or apparatuses. When more than one such devices systems or apparatuses are in the preset state, these may be selected according to priorities predefined by the user, as described.

The returning module 93 may be configured to return a notification message to the notification sending equipment. In some aspects, the returning module 93 may return the notification message when the determination module 91 determines that the notification receiving equipment is not in the preset state. If the notification receiving equipment is not in the in-service state or the immersive experience state, the gateway may return the notification message to the notification sending equipment. When the notification sending equipment receives the notification message sent by the gateway, the notification receiving equipment may not make the prompt about the notification information. At this moment, the notification sending equipment may then perform a prompting operation based on the notification information, as described.

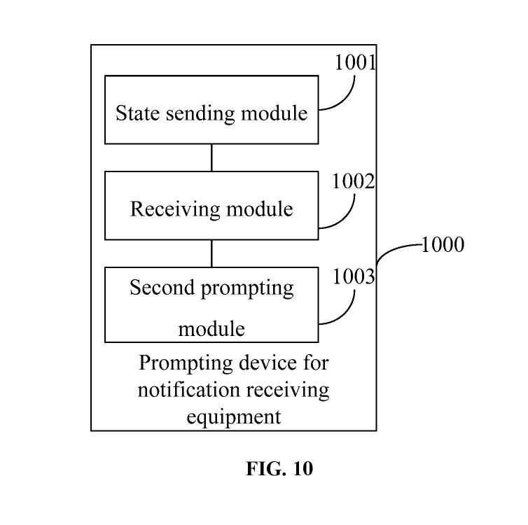

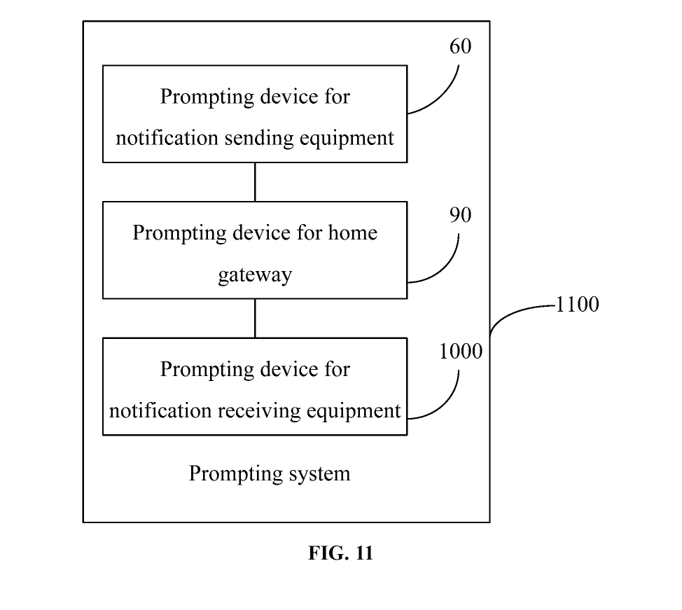

FIG. 10 is a block diagram illustrating a prompting device, in accordance with aspects of the present disclosure. The device may be implemented into a part or entire of the notification receiving equipment through software, hardware or a combination thereof. As shown in FIG. 10, the prompting device 1000 for the notification receiving equipment may include a state sending module 1001, a receiving module 1002 and a second prompting module 1003.

The state sending module 1001 is configured to send a current state to a gateway, such as in-service state or an out-of-service state. The notification receiving equipment may send its current state to the gateway in real time, thereby making it convenient for the gateway to determine whether to forward received notification information sent by notification sending equipment to the notification receiving equipment or not according to the state of the notification receiving equipment.

Herein, if the notification receiving equipment is in the in-service state, the gateway may forward the notification information sent by the notification sending equipment to the notification receiving equipment, so that the notification receiving equipment provides a prompt about the notification information. In this manner, as long as the notification receiving equipment is in service, the notification receiving equipment provide the prompt about the notification information for a user to acquire the prompt. If the notification receiving equipment is in the out-of-service state, the gateway may return a notification message to the notification sending equipment. When the notification sending equipment receives the notification message sent by the gateway, the notification receiving equipment need not make the prompt about the notification information. The notification sending equipment may then perform the prompting operation on the notification information, as described.

If the notification receiving equipment is in the immersive experience state, the notification information received by the notification sending equipment may also be forwarded to the notification receiving equipment, so that the notification receiving equipment makes the prompt about the notification information. In this manner, the user in an immersive experience may be prevented from missing any external important prompt, and user experiences are improved. Herein, when a headset is plugged into a mobile phone, VR equipment is started and a volume of a television is higher than a certain threshold value, it may be judged that the current equipment is in the immersive experience state.

The receiving module 1002 is configured to receive a notification message from notification sending equipment sent by the gateway. The second prompting module 1003 is configured to perform a message prompting operation according to the notification message received by the receiving module 1002. In one embodiment, the notification sending equipment may be configured to send the notification information to the gateway when receiving the notification information. The gateway may then forward the notification information to the notification receiving equipment in the in-service state or in the immersive experience state, so that the notification receiving equipment makes a prompt about the notification information. In this manner, when a user is utilizing an immersive experience product, the notification information may be forwarded to the immersive experience product. As described, this ensures that the user in the immersive experience may receive important prompting information on the immersive experience product, thereby preventing the user from missing the important prompting information, and improving user experiences.

FIG. 11 is a block diagram illustrating a prompting system, in accordance with aspects of the present disclosure. As shown, the prompting system 1100 may include a prompting device 60 for notification sending equipment, a prompting device 90 for a gateway and a prompting device 1000 for notification receiving equipment.

The notification sending equipment may send notification information to the gateway when receiving the notification information. The gateway may then forward the notification information to the notification receiving equipment that is in an in-service state or in an immersive experience state. The notification receiving equipment may then provide a prompt about the notification information. This allows a user utilizing an immersive experience product to receive the notification information by way of the immersive experience product, as described.

According to one embodiment of the present disclosure, a prompting device is provided. The device may include a processor, and a memory configured to store instructions executable by the processor, wherein the processor is configured to when notification information is received, send the notification information to a gateway, or home gateway, connected with the notification sending equipment, and receive a feedback of the gateway and execute a corresponding prompting action. The processor may further be configured to receive a notification message returned by the gateway, and perform a message prompting operation according to the notification message. The processor may further be configured to receive prompting information sent by the gateway, the prompting information being sent when the gateway acquires that a current state of the notification sending equipment meets a preset state, and execute the step of sending the notification information to the gateway when the notification sending equipment receives the notification information according to the received prompting information. The preset state includes an immersive experience state. According to another embodiment of the present disclosure, a prompting device is provided. The device may include a processor, and a memory configured to store instructions executable by the processor, wherein the processor is configured to when notification information sent by notification sending equipment connected to the gateway is received, determine whether notification receiving equipment connected to the home gateway is in a preset state, when it is determined that the notification receiving equipment is in the preset state, forward the notification information to the notification receiving equipment, and when it is determined that the notification receiving equipment is not in the preset state, return a notification message to the notification sending equipment. The preset state includes an in-service state and an immersive experience state.

According to yet another aspect of the present disclosure, a prompting device is provided. The device may include a processor, and a memory configured to store instructions executable by the processor, wherein the processor is configured to send a current state to a gateway, receive a notification message sent by the gateway from notification sending equipment, and perform a message prompting operation according to the notification message. The current state includes an in-service state or an out-of-service state and an immersive experience state.

According to yet another aspect of the present disclosure, a prompting system is provided. The prompting system may include a notification sending equipment, a gateway, and a notification receiving equipment, each according to embodiments, as described above.

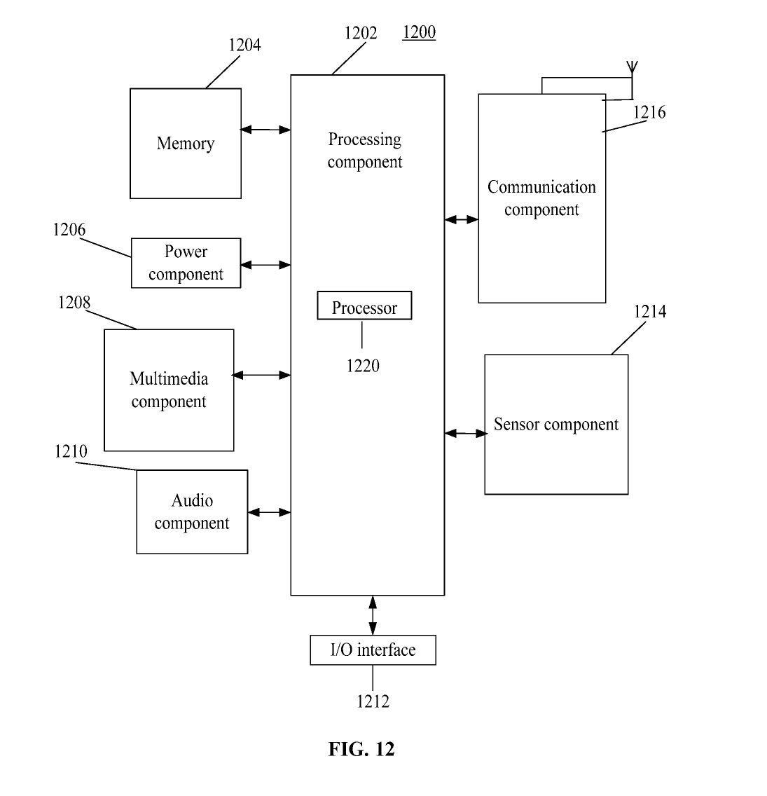

FIG. 12 is a block diagram illustrating a prompting device 1200 in accordance with aspects of the present disclosure. In some embodiments, the device may be applicable to notification sending equipment and notification receiving equipment, as described. As non-limiting examples, the device 1200 may be a mobile phone, a computer, a digital broadcast terminal, a messaging device, a gaming console, a tablet, a medical device, exercise equipment, a personal digital assistant or the like.

The device 1200 may include one or more of the following components: a processing component 1202, a memory 1204, a power component 1206, a multimedia component 1208, an audio component 1210, an Input/Output (I/O) interface 1212, a sensor component 1214, and a communication component 1216.

The processing component 1202 typically controls overall operations of the device 1200, such as the operations associated with display, telephone calls, data communications, camera operations, and recording operations. The processing component 1202 may include one or more processors 1220 to execute instructions to perform all or part of the steps in the abovementioned processes or methods. Moreover, the processing component 1202 may include one or more modules which facilitate interaction between the processing component 1202 and the other components. For instance, the processing component 1202 may include a multimedia module to facilitate interaction between the multimedia component 1208 and the processing component 1202.

The memory 1204 is configured to store various types of data to support the operation of the device 1200. Examples of such data include instructions for any application programs or methods operated on the device 1200, contact data, phonebook data, messages, pictures, video, etc. The memory 1204 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 1206 provides power for various components of the device 1200. The power component 1206 may include a power management system, one or more power supplies, and other components associated with the generation, management and distribution of power for the device 1200.

The multimedia component 1208 includes a screen providing an output interface between the device 1200 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also sense a duration and pressure associated with the touch or swipe action. In some embodiments, the multimedia component 1208 includes a front camera and/or a rear camera. The front camera and/or the rear camera may receive external multimedia data when the device 1200 is in an operation mode, such as a photographing mode or a video mode. Each of the front camera and the rear camera may be a fixed optical lens system or have focusing and optical zooming capabilities.

The audio component 1210 is configured to output and/or input an audio signal. For example, the audio component 1210 includes a Microphone (MIC), and the MIC is configured to receive an external audio signal when the device 1200 is in the operation mode, such as a call mode, a recording mode and a voice recognition mode. The received audio signal may be further stored in the memory 1204 or sent through the communication component 1216. In some embodiments, the audio component 1210 further includes a speaker configured to output the audio signal.

The I/O interface 1212 provides an interface between the processing component 1202 and a peripheral interface module, and the peripheral interface module may be a keyboard, a click wheel, a button or the like. The button may include, but not limited to: a home button, a volume button, a starting button and a locking button. The sensor component 1214 includes one or more sensors configured to provide status assessment in various aspects for the device 1200. For instance, the sensor component 1214 may detect an on/off status of the device 500 and relative positioning of components, such as a display and small keyboard of the device 1200, and the sensor component 1214 may further detect a change in a position of the device 1200 or a component of the device 1200, presence or absence of contact between the user and the device 1200, orientation or acceleration/deceleration of the device 1200 and a change in temperature of the device 1200. The sensor component 1214 may include a proximity sensor configured to detect presence of an object nearby without any physical contact. The sensor component 1214 may also include a light sensor, such as a Complementary Metal Oxide Semiconductor (CMOS) or Charge Coupled Device (CCD) image sensor, configured for use in an imaging application. In some embodiments, the sensor component 1214 may also include an acceleration sensor, a gyroscope sensor, a magnetic sensor, a pressure sensor or a temperature sensor.

The communication component 1216 is configured to facilitate wired or wireless communication between the device 1200 and another device. The device 1200 may access a communication-standard-based wireless network, such as a WIFI network, a 2nd-Generation (2G) or 3rd-Generation (3G) network or a combination thereof. In an exemplary embodiment, the communication component 1216 receives a broadcast signal or broadcast associated information from an external broadcast management system through a broadcast channel. In an exemplary embodiment, the communication component 1216 further includes a Near Field Communication (NFC) module to facilitate short-range communication. For example, the NFC module may be implemented on the basis of a Radio Frequency

Identification (RFID) technology, an Infrared Data Association (IrDA) technology, an Ultra-WideBand (UWB) technology, a Bluetooth (BT) technology and another technology.

In an exemplary embodiment, the device 1200 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In an exemplary embodiment, there is also provided a non-transitory computer-readable storage medium including an instruction, such as the memory 1204 including an instruction, and the instruction may be executed by the processor 1220 of the device 1200 to implement the abovementioned method. For example, the non-transitory computer-readable storage medium may be a ROM, a Radom Access Memory (RAM), a Compact Disc Read-Only Memory (CD-ROM), a magnetic tape, a floppy disc, an optical data storage device or the like.

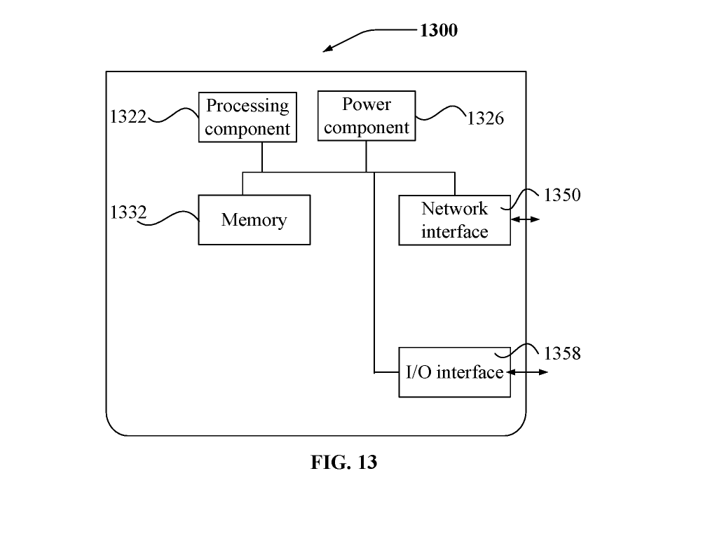

FIG. 13 is a block diagram illustrating a prompting device in accordance with aspects of the present dislcosure. For example, the device 1300 may be a gateway. The device 1300 may include a proceessing component 1322, with one or more processors, and a memory resource represented by a memory 1332. Specifically, the memory 1332 may be configured to store instructions executable by the processing component 1322, such as application programs. The application programs stored in the memory 1332 may include one or more than one module of which each corresponds to a set of instructions. In addition, the processing component 1322 is configured to execute the instructions, so as to execute the abovementioned method.

The device 1300 may also include a power component 1326 configured to execute power mangement of the device 1300, a wired or wireless network interface 1350 configured to connect the device 1300 to a network, and an I/O interface 1358. The device 1300 may be operated by way of an operating system stored in the memory 1332, such as Windows Server™, Mac OS X™, Unix™, Linux™ or FreeBSD™.

In accordance with yet another aspect of the present disclosure, a non-transitory computer-readable storage medium is provided. In some embodiments, the non-transitory computer-readable storage medium may include instructions executable by one or more processors, such as a processor according to the above-described device 1200, to carry out abovementioned prompting methods.

In some aspects, a method provided on the non-transitory computer-readable storage medium may include, when notification information is received, sending the notification information to a gateway connected with notification sending equipment, receiving a feedback of the gateway, and executing a prompting action. In some aspects, receiving the feedback of the gateway and executing the prompting action may include receiving a notification message returned by the home gateway, and performing a message prompting operation according to the notification message. In other aspects, receiving the feedback of the gateway and executing the prompting action may include receiving prompting information sent by the gateway, the prompting information being sent when the gateway determines that a current state of the notification sending equipment meets a preset state, and executing the step of sending the notification information to the gateway when the notification sending equipment receives the notification information according to the received prompting information. In some aspects, the preset state may include an immersive experience state.

In accordance with yet another aspect of the present disclosure, a non-transitory computer-readable storage medium is provided. In some embodiments, the non-transitory computer-readable storage medium may include instructions executable by one or more processors, such as a processor according to the above-described device 1200, to carry out abovementioned prompting methods. In some aspects, a method provided on the non-transitory computer-readable storage medium may include receiving a notification message sent by the gateway from notification sending equipment, and performing a message prompting operation according to the notification message.

In accordance with yet another aspect of the present disclosure, a non-transitory computer-readable storage medium is provided. In some embodiments, the non-transitory computer-readable storage medium may include instructions executable by one or more processors, such as a processor according to the above-described device 1300, to carry out abovementioned prompting methods.

In some aspects, a method provided on the non-transitory computer-readable storage medium may includee, when notification information sent by notification sending equipment connected to a gateway is received, determining whether notification receiving equipment connected to the gateway is in a preset state, when it is determined that the notification receiving equipment is in the preset state, forwarding the notification information to the notification receiving equipment, and when it is determined that the notification receiving equipment is not in the preset state, returning a notification message to the notification sending equipment. In some aspects, the preset state includes an in-service state or an immersive experience state.

Other embodiments of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

What is claimed is:

1. A prompting method comprising:
generating notification information using a notification sending equipment;
sending the notification information to a gateway connected to the notification sending equipment;
receiving feedback from the gateway; and
executing a prompting action based on the feedback.

2. The method of claim 1, further comprising:
receiving a notification message from the gateway; and
performing a message prompting operation according to the notification message.

3. The method of claim 1, wherein receiving the feedback of the gateway and executing the corresponding prompting action comprises:
receiving prompting information sent by the gateway, the prompting information being sent when the gateway determines that a current state of the notification sending equipment meets a preset state; and
triggering to execute the step of sending the notification information to the gateway when the notification sending equipment receives the notification information according to the received prompting information.

4. The method of claim 3, wherein the preset state comprises an immersive experience state.

5. The method of claim 1, further comprising:
determining, by the gateway, whether a notification receiving equipment connected to the gateway is in a preset state when notification information sent by notification sending equipment connected to the home is received;
forwarding the notification information to the notification receiving equipment when it is determined that the notification receiving equipment is in the preset state; and
returning a notification message to the notification sending equipment when it is determined that the notification receiving equipment is not in the preset state.

6. The method of claim 5, wherein the preset state comprises an in-service state.

7. The method of claim 5, wherein the preset state comprises an immersive experience state.

8. The method of claim 1, further comprising:
sending a current state of the notification receiving equipment to a gateway by the notification receiving equipment;
receiving a notification message from a notification sending equipment sent by the gateway; and
performing a message prompting operation according to the notification message.

9. The method of claim 8, wherein the current state of the notification receiving equipment comprises an in-service state or an out-of-service state.

10. The method of claim 8, wherein the current state of the notification receiving equipment comprises an immersive experience state.

11. A prompting device comprising:
a processor; and
a memory configured to store instructions executable by the processor,
wherein the processor is configured execute the instructions to:
receive notification information;
send the notification information to a gateway connected with a notification sending equipment;
receive a feedback from the gateway; and
execute a prompting action based on the feedback.

12. The device of claim 11, wherein the processor is further configured to:
receive a notification message returned by the gateway; and
perform a message prompting operation according to the received notification message.

13. The device of claim 11, wherein the processor is further configured to:
receive prompting information sent by the gateway, the prompting information being sent when the gateway determines that a current state of the notification sending equipment meets a preset state; and
trigger to send notification information to the gateway according to the received prompting information.

14. The device of claim 13, wherein the preset state comprises an immersive experience state.

15. A prompting device comprising:
a processor; and
a memory configured to store instructions executable by the processor, wherein the processor is configured to execute the instructions to:
determine whether a notification receiving equipment connected to a gateway is in a preset state when notification information sent by a notification sending equipment connected to the gateway is received;
forward the notification information to the notification receiving equipment if it is determined that the notification receiving equipment is in the preset state; and
return a notification message to the notification sending equipment if it is determined that the notification receiving equipment is not in the preset state.

16. The device of claim 15, wherein the preset state comprises an in-service state.

17. The device of claim 16, wherein the preset state comprises an immersive experience state.

18. A prompting device comprising:
a processor; and
a memory configured to store instructions executable by the processor, wherein the processor is configured to execute the instructions to:
send a current state of a notification receiving equipment to a gateway;
receive a notification message from a notification sending equipment sent by the gateway; and
perform a message prompting operation according to the notification message.

19. The device of claim 18, wherein the state of the notification receiving equipment comprises an in-service state or an out-of-service state.

20. The device of claim 18, wherein the state of the notification receiving equipment comprises an immersive experience state.
